(19) United States
(12) Patent Application Publication
(10) Pub. No.: US 2006/0144162 A1
(43) Pub. Date: Jul. 6, 2006

(54) Method and apparatus for evaluating fluid flow in a heat exchanger

(76) Inventors: Thomas James Batzinger, Burnt Hills, NY (US); Shridhar Champaknath Nath, Niskayuna, NY (US); Kenneth Gordon Herd, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/028,694

(22) Filed: Jan. 5, 2005

(51) Int. Cl. G01F 1/66

(52) U.S. Cl. 73/861.25

(57) ABSTRACT

A method for diagnosing a vessel having a casing with multiple isolated fluid pathways disposed therein, is provided. The vessel provides for at least one fluid flow. The method includes disposing an ultrasonic device proximate to the vessel, emitting multiple ultrasonic probe signals from the ultrasonic device, evaluating the reflected signals for at least one characteristic of the at least one fluid flow through the flow area, and generating a set of fluid flow characteristics of the flow area based on the evaluating. The probe signals are configured to interact with a flow area and generate multiple reflected signals.

### BACKGROUND

The invention relates generally to diagnostic systems for vessels having fluid flows, and more particularly to ultrasonic diagnostic systems and methods for evaluating fluid flow in vessels.

Most fluid flow applications in vessels, industrial or domestic, for example fluid flow in heat exchangers, suffer from flow related aberrations. These aberrations may be caused by flow- or vessel-associated phenomenon such as fouling, other blockages in fluid flow paths or tubes, cracks in the tubes carrying the fluids, and many other similar factors. Typically, such factors are detrimental to the performance of the vessels. For example, blockages disrupt the fluid flows, causing a loss in the flow rates of the fluid, and hence the overall effectiveness or capacity of the vessel. Such blockages, in case of heat exchangers, may also prevent fluid flows from reaching desired regions for heat transfer, causing a heat transfer reduction and associated financial losses. Fouling is the deposition of materials in the fluid onto the fluid pathway surfaces, such as pipe or vessel casing surfaces. Various fouling scenarios include significant deposition amounts that obstruct fluid flow, depositions corrosive to the pipes or vessel surfaces, or thermally insulating depositions on the pipes or vessel casing surfaces. These conditions are detrimental to the performance of vessels, especially industrial vessels such as heat exchangers that are designed to transfer heat out from or in to at least one fluid flow. Fouling decreases the efficiency of thermal energy transfer and causes obstruction in the fluid flow, decreasing the net fluid flow rate, among other disadvantages. In severe cases, fouling may hamper the heat exchanger efficiencies significantly, causing energy losses and associated cost losses.

Such problems, commonly associated with fluid flow applications are typically remedied by monitoring overall fluid flow characteristics such as overall mass flows, overall fluid flow stream temperatures and pressures, and using these measures as an indication of the thermal dynamics of the heat exchanger. These techniques are not very sensitive to subtle changes in the fluid flow characteristics, and are limited in their efficacy in indicating blockages at early stages or preventing early onset of fouling. In some cases, despite conventional monitoring, fouling may severely decrease the thermal efficiency. In such conditions the heat exchanger needs to be removed from service and disassembled for cleaning and inspection, which leads to a loss due to down-time in addition to thermal losses.

Therefore, it would be advantageous to have techniques and apparatuses that could provide data indicating an onset of fouling in heat exchangers, providing information on fluid flow characteristics of specific sections of flow areas. It would be further advantageous to have a real time graphical display of fluid flow characteristics, a capability to analyze the fluid flow in specific regions of the vessel, and locate specific fouling sites. Accordingly, there exists a need for a diagnostic system that provides for a substantially accurate monitoring and diagnostic system for vessels having fluid flows.

### SUMMARY

An exemplary embodiment of the invention provides a method for diagnosing a vessel having a casing with a plurality of isolated fluid pathways disposed therein, the vessel providing for at least one fluid flow. The method includes disposing at least one ultrasonic device proximate to the vessel, emitting a plurality of ultrasonic probe signals from the at least one ultrasonic device, evaluating the plurality of reflected signals for at least one characteristic of the at least one fluid flow through the flow area, and generating a set of fluid flow characteristics of the flow area based on said evaluating. The probe signals are configured to interact with a flow area and generate a plurality of reflected signals.

Another exemplary embodiment of the invention provides a method for examining a vessel for fouling, the vessel providing for at least one fluid flow. The method includes disposing an ultrasonic device proximate to the vessel, emitting from the ultrasonic device a plurality of ultrasonic probe signals configured to interact with a flow area and generate a plurality of reflected signals, evaluating the plurality of reflected signals, and generating an image of the flow area indicating a set of fluid flow characteristics of the at least one fluid flow in a specific section of the flow area.

Another exemplary embodiment of the invention provides a fluid flow path diagnostic system. The system includes at least one ultrasonic device disposed proximate to a vessel and a controller coupled to the at least one ultrasonic device. The controller has a casing with a plurality of isolated fluid pathways disposed therein. The at least one ultrasonic device is configured to emit probe signals into the vessel and receive reflected signals from within the vessel. The controller is configured to instruct the at least one ultrasonic device to emit probe signals to interact with a flow area, evaluate the reflected signals received by the at least one ultrasonic device, and generate fluid flow characteristics of the flow area based on the reflected signals.

These and other advantages and features will be more readily understood from the following detailed description of preferred embodiments of the invention that is provided in connection with the accompanying drawings.

### BRIEF DESCRIPTION OF THE DRAWINGS

FIG. 1 is a cross sectional view of a heat exchanger vessel according to an aspect of the present invention.

FIG. 2 is a partial cross sectional view of the heat exchanger of FIG. 1.

FIG. 3 is a cross sectional view of a flow area inside an isolated fluid pathway of FIG. 2.

FIG. 4 is a flow diagram illustrating a method to evaluate fluid flow characteristic in a vessel according to an aspect of the invention.

### DETAILED DESCRIPTION OF PREFERRED EMBODIMENTS

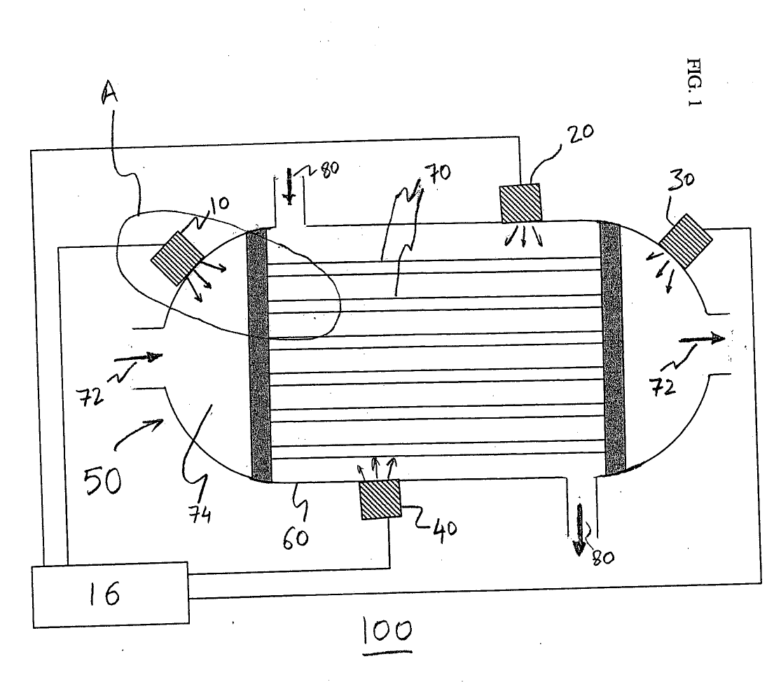

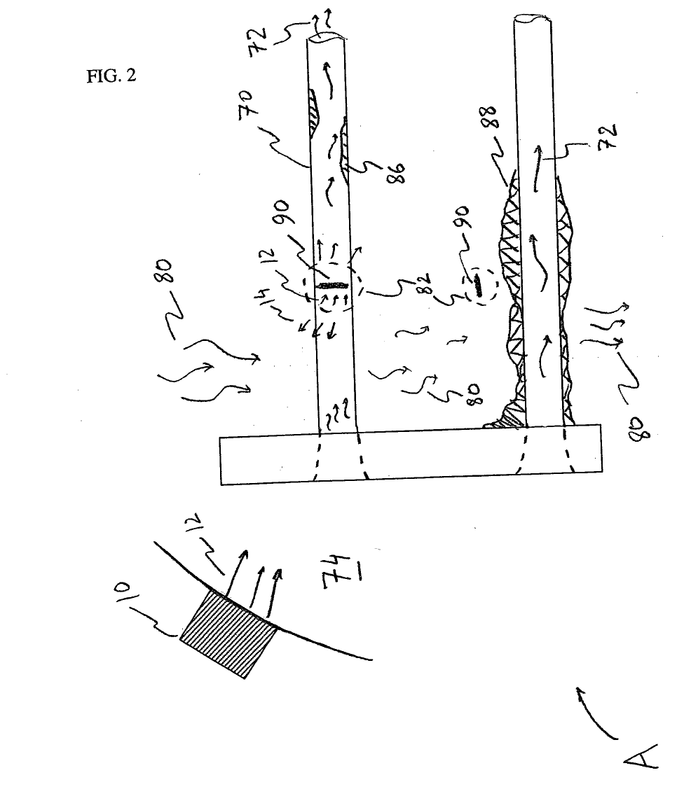

FIGS. 1 and 2 illustrate a fluid flow path diagnostic system 100 according to an embodiment of the invention. The system 100 is configured to diagnose fluid flow paths in a vessel 50 including a casing 60 and multiple isolated fluid pathways, such as pipes, 70. A process material fluid flow, or a primary flow, is characterized by the numeral 72, whereas a cooling/heating material fluid flow, or a secondary flow, is referred to by the numeral 80. In one embodiment, the two fluid flows 72 and 80 are configured to interact thermally within the vessel and remain physically separate. At least one ultrasonic device 10 is disposed proximate to (on or around) the vessel 50. FIG. 1 illustrates multiple such ultrasonic devices 20, 30, 40 also disposed on the vessel 50. Each ultrasonic device is capable of at least emitting ultrasonic probe signals 12, or receiving signals resulting from an interaction of the ultrasonic probe signals with a relevant flow area 82 (FIG. 2), or both. The signals resulting from an interaction of the probe signals 12 with the flow area are referred to as reflected signals 14.

In the embodiment of FIGS. 1 and 2, the ultrasonic devices are phased array ultrasonic devices 10, 20, 30, 40. The phased array ultrasonic devices are configured to emit ultrasonic signal beams configured to be oriented towards flow areas at selectable distances and selectable orientations. Phased array ultrasonic devices consist of an array of ultrasonic piezoelectric elements, each of which is electronically controllable by a processing device, such as a controller. A suitable number of elements are activated in a sequence according to a timing scheme arrived at by the processing device to get desired probe signal beam characteristics, such as steering the beam to a desired distance and angle. The beam may be steered to different locations within the vessel. It is noted here that the ultrasonic devices are capable of directing the probe signals 12 along all three coordinate axes, that is, along the length of the vessel (along the pipes 70) or anywhere in the plane perpendicular to the pipes 70, covering full field of flow within the vessel 50. The phased array ultrasonic devices may also be configured for receiving reflected signals 14, which may then be analyzed by the processing device. More specifically, FIG. 1 illustrates a controller 16 coupled to the phased array ultrasonic devices 10, 20, 30, 40. The controller 16 is configured to instruct the phased array ultrasonic device 10 to emit probe ultrasonic signals 12 to interact with a target flow area 82, as also illustrated in FIG. 2, which is a detailed view of region A of FIG. 1. Upon interaction of the probe signals 12 with the flow area 82, reflected signals 14 are generated. These reflected signals 14 may be received by another phased array ultrasonic device 20, 30, 40, or as illustrated herein the reflected signals 14 are received by the same phased array ultrasonic device 10, and may then be analyzed by a processing device. The flow area 82 may be selected as a region within the pipes 70 or outside the pipes, depending upon which fluid flow path is being analyzed.

Fouling in the vessel 50, inside the pipes 70 or outside the pipes but within the casing 60 may lead to blockages in the vessel 50. For example, FIG. 2 illustrates a fouling site 86 that obstructs the fluid flow 72 within the pipe 70. Another fouling site 88 exists in the casing 60 outside the pipes 70 obstructing fluid flow 80 within the casing. A presence of these obstructions causes a variation in the characteristics of the associated fluid flows 72, 80. For example, the fouling site 86 may cause a lower fluid velocity, turbulent flows, low mass flow rates of the fluid flow 72 through the pipe 70 or in the region around the fouling site 86. Similar effects may be observed in the fluid flow 80 flowing through the casing 60 outside the pipes 70, due to the fouling site 88. It is noted here, that fouling sites 86, 88 are exaggerated in the illustrations for clarity, and may be much smaller in dimensions in some real cases. However, even small amounts of fouling cause significant thermal transfer losses, lowering the efficiency of thermal exchange vessels, such as heat exchangers. Additionally, these small amounts of fouling may cause subtle changes in the fluid flow characteristics. According to an aspect of the invention, these changes in the fluid flow characteristics are detected and analyzed to generate indications about a state of fouling and the location of the fouling sites, such as sites 86, 88. It is appreciated here that fouling is just one of the factors altering fluid flow characteristics, and though for the purpose of this discussion examples of fouling have been extensively used, embodiments of the invention are not restricted to identifying only fouling but also include various other factors that may cause a change in the fluid flow characteristics. Accordingly, embodiments of the invention should be construed as being applicable broadly to fluid flows within vessels.

In one embodiment, the ultrasonic device is a phased array ultrasonic device 10, which focuses the probe signals 12 to interact with a selected flow area 82, within the pipe 70. As discussed, this is done by selectively energizing array elements of the phased array ultrasonic device according to a devised sequence. These probe signals 12 interact with the material inside the flow area 82 and emerge as reflected signals 14 as a product of the interaction. The reflected signals 14 carry specific information on the fluid flow velocity, fluid flow direction, and mass flow rate for the flow area 82, among other parameters. In one embodiment, the probe signals 12 are generated according to a Doppler flow imaging methodology. Doppler flow imaging utilizes a frequency shift of the probe signals, which is captured in the reflected signals 14. The frequency shift is due to an interaction of the probe signals 12 with various particulate matter or other scattering material in the fluid flow, or the phase of the fluid flows. The reflected signals 14 are then received by the phased array ultrasonic device 10, which is coupled to the controller 16. The controller is configured to analyze the reflected signals 14 received by the phased array ultrasonic device 10 to generate fluid flow characteristics of the fluid flow 72 in the pipe 70. The fluid flow characteristics so generated may be represented as an image of a cross-section 90 of the flow 72 in the flow area 82 for further analysis.

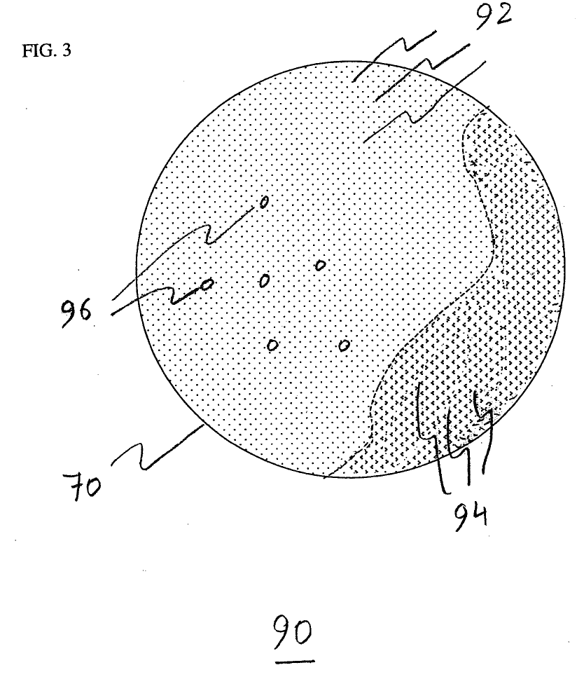

An example of such a representation is seen in the schematic illustration of FIG. 3, which represents the cross-section 90 within the pipe 70. For illustrative purposes only, the flow 72 within the pipe 70 is categorized into fast, normal and slow. The fluid particles moving at fast, normal and slow velocities are represented by numerals 96, 92 and 94 respectively. The region 98, demarcated by a dotted line, primarily comprises slow or stagnant fluid flow particles 94, indicating an obstruction in the vicinity of the flow area 82, such as from a fouling site 86. Fast moving particles 96 may indicate the presence of a turbulent flow, which may indicate the presence of a fouling site in the vicinity of the flow area 82. On the other hand, if the cross-section 90 comprises of primarily normal flow velocity particles 92, it would indicate a fouling free region around the flow area 82. It should be appreciated that the classification into fast, normal and slow velocity is done for illustrative purposes only, and is not intended to limit the embodiments.

In one embodiment, the controller 16 is configured for generating the fluid flow characteristics as an image, displaying information such as fluid flow direction, flow velocity distribution, mass flow rate, boundary layer detection, type of flows (laminar or turbulent), among other parameters. It is appreciated that a processing device other than the controller 16 alternately may be used for generating fluid flow characteristic images. The fluid flow diagnostic system 100 may include a displaying device such as a monitor (not shown in the figures), configured to display the fluid flow characteristic image generated by the controller 16. In one embodiment, the fluid flow characteristics are visualized by using different colors for indicating substantially accurate flow direction and flow velocities.

The fluid flow characteristics so obtained capture the subtle changes in the fluid flow, and are useful for indicating an onset of fouling in the heat exchanger. For example, areas of poor fluid flow or fluid flow in disagreement with the design intent of the vessel are identifiable by analyzing minor variations in overall flow velocity distribution, mass flow rate, boundary layer detection, nature of the flow (turbulent or laminar), among other flow characteristics, thereby indicating a state of fouling and a location of the fouling site. Also, a comparison from a previous state of fluid flow characteristics may indicate presence of fouling or an onset of fouling. Loss in thermal efficiency and unusual fluid flow patterns also indicate presence of fouling. In one embodiment, an evaluation of the fluid flow 72 is made as the fluid flow transitions from an entry area 74 of the primary fluid into each of the tube 70. If the evaluation of the fluid flow pattern of a specific tube 70 indicates restricted flow, fouling or plugging in that tube 70 may be presumed. In another embodiment, an evaluation of the secondary fluid flow 80 is made around the tube 70 to indicate flow areas in which the secondary fluid is no longer flowing due to fouling, thereby leading to heat exchanger inefficiency.

The controller 16 is further configured to determine a state of fouling in the vessel 50 in regions associated with the flow areas 82, based on the fluid flow characteristics by inferring the information. Alternately, the information may be inferred by a manual operator analyzing the image to determine a location and nature of the fouling site(s). Additionally, based on the analysis of generated images, more probable locations of fouling sites may be indicated, and such locations may be probed iteratively to identify the fouling sites. Although FIG. 3 illustrates the flow area 82 associated with the flow 72 within the pipe 70, and the fluid flow characteristics generated are of the flow 72 indicating the fouling site 86 within the pipe 70, it will be appreciated that the methodology and apparatuses are similarly applicable for flow 80 outside the pipes 70 for identifying fouling sites 88 outside the pipes 70.

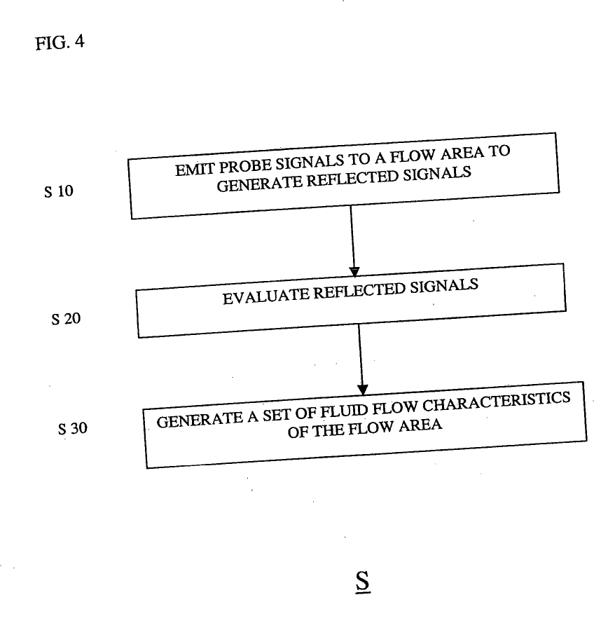

FIG. 4 illustrates a method S for diagnosing a vessel according to an embodiment of the invention. At least one ultrasonic device 10 is disposed proximate to the vessel 50. This includes disposing the ultrasonic device(s) on the vessel 50, although in some embodiments the ultrasonic device(s) may be disposed nearby the vessel 50, having an ultrasonic transmission capability by providing a solid physical medium between the vessel 50 and the ultrasonic device(s). At Step S10, the ultrasonic device emits ultrasonic probe signals 12 configured to interact with a flow area 82 within the vessel 50, the flow area 82 having an associated fluid flow. On interaction of the probe signals 12 with the flow area 82 reflected signals 14 are generated. At Step S20, the reflected signals 14 are evaluated for determining a characteristic of the fluid flow associated with the flow area, and a set of fluid flow characteristics is generated at Step S30. The generated fluid flow characteristics may include fluid flow direction, flow velocity distribution, mass flow rate, boundary layer detection, type of flows (laminar or turbulent), among other characteristics. Based on these characteristics, a state of fouling in a region associated with the flow area may be determined.

After a state of fouling has been determined, including indicating a location and a size of the fouling site, appropriate remedial strategies may be employed. Remedial strategies include mechanical cleaning and chemical cleaning. While chemical cleaning involves passing a fluid having chemicals that act as solvents for fouling materials, mechanical cleaning involves physically removing the fouling material from the site identified with the help of methods and systems as listed above, and requires the vessels such as heat exchangers to be shut down to carry out the cleaning process separately. Accordingly for large amounts of fouling, or fouling in zones where fluid flow is less, mechanical cleaning may be employed, whereas in areas where mechanical intervention is not feasible or fouling amounts are less, chemical cleaning may be preferred, and appropriate remedies will occur to those skilled in the art according to the operating conditions.

The disclosed methods and systems advantageously provide for a substantially accurate monitoring and diagnostic system for vessels having fluid flows, such as heat exchangers. Fouling or other problems associated with fluid flow vessels can be identified and arrested or remedied at very early stages, saving heat losses, and associated financial losses, increasing efficiency and life of the vessel. Another advantage is the real time monitoring of the flows within the vessel. Yet another advantage is a substantially accurate monitoring of the fluid flow characteristics, not only overall, but also within specific regions (flow areas) of the vessel. The methods and systems described, among various other advantages that will be apparent to those skilled in the art, allow for a planned maintenance of the vessels, and by providing early indications of fouling, allow for a proactive mitigation by remedial measures (such as chemical or mechanical cleaning), and also provide a monitor on the efficiency.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for diagnosing a vessel comprising a casing with a plurality: of isolated fluid pathways disposed therein, the vessel providing for at least one fluid flow, the method comprising:
disposing at least one ultrasonic device proximate to the vessel;
emitting a plurality of ultrasonic probe signals from the at least one ultrasonic device, the probe signals configured to interact with a flow area and generate a plurality of reflected signals;
evaluating the plurality of reflected signals for at least one characteristic of the at least one fluid flow through the flow area; and
generating a set of fluid flow characteristics of the flow area based on said evaluating.

2. The method of claim 1, wherein the at least one ultrasonic device is a phased array ultrasonic device.

3. The method of claim 1, wherein emitting the plurality of ultrasonic probe signals comprises focusing the plurality of ultrasonic probe signals to the flow area.

4. The method of claim 1, wherein the plurality of ultrasonic probe signals are emitted according to Doppler flow imaging methodology.

5. The method of claim 1, wherein said generating comprises generating an image of the flow area indicating a velocity of the at least one fluid flow in a specific section of the flow area.

6. The method of claim 1, wherein the at least one characteristic is selected from the group consisting of a fluid flow velocity, a fluid mass flow rate, a fluid flow direction and combinations thereof.

7. The method of claim. 1, wherein the flow area is located within one of the plurality of isolated fluid pathways.

8. The method of claim 1, wherein the flow area is located outside the isolated fluid pathways and inside the casing.

9. The method of claim 1, further comprising determining a state of fouling in the vessel in a region associated with the flow area based on said generating.

10. The method of claim 9, further comprising:
classifying the state of fouling based on an amount of fouling and a location of fouling; and
providing a remedial strategy based on said classifying.

11. The method of claim 10, wherein the remedial strategy is chemical cleaning.

12. The method of claim 10, wherein the remedial strategy is mechanical cleaning.

13. A method for examining a vessel for fouling, the vessel providing for at least one fluid flow, the method comprising:
disposing an ultrasonic device proximate to the vessel;
emitting from the ultrasonic device a plurality of ultrasonic probe signals configured to interact with a flow area and generate a plurality of reflected signals;
evaluating the plurality of reflected signals; and
generating an image of the flow area indicating a set of fluid flow characteristics of the at least one fluid flow in a specific section of the flow area.

14. A fluid flow path diagnostic system comprising:
at least one ultrasonic device disposed proximate to a vessel comprising a casing with a plurality of isolated fluid pathways disposed therein, the at least one ultrasonic device configured to emit probe signals into the vessel and receive reflected signals from within the vessel; and
a controller coupled to the at least one ultrasonic device, wherein the controller is configured to:
instruct the at least one ultrasonic device to emit probe signals to interact with a flow area;
evaluate the reflected signals received by the at least one ultrasonic device; and
generate fluid flow characteristics of the flow area based on the reflected signals.

15. The system of claim 14, wherein the ultrasonic device is a phased array ultrasonic device.

16. The system of claim 14, wherein the ultrasonic device is configured to focus the probe signals to the flow area.

17. The system of claim 16, wherein the controller instructs the ultrasonic device to focus the probe signals to the flow area.

18. The system of claim 14, wherein the ultrasonic device is configured to emit the probe signals according to Doppler flow imaging methodology.

19. The system of claim 14, wherein the controller is configured to generate an image of the flow area based on the reflected signals received by the at least one ultrasonic device.

20. The system of claim 19, wherein the generated image indicates at least one of a velocity of the fluid flow, a direction of the fluid flow, a mass flow rate of the fluid flow, and combinations thereof.

21. The system of claim 14, wherein the controller is configured to determine a state of fouling in the vessel in a region associated with the flow area based on the characteristic selected from the group consisting of a fluid flow velocity, a fluid flow direction, a mass flow rate and combinations thereof.

22. The system of claim 14, wherein the controller is configured to determine a state of fouling in a region associated with the flow area of the vessel based on said generating, the controller further configured to:
classify the state of fouling based on an amount of the fouling and location of the fouling; and
provide a remedial strategy based on said classification.
